(19) United States
(12) Patent Application Publication
(10) Pub. No.: US 2016/0219864 A1
(43) Pub. Date: Aug. 4, 2016

(54) Portable mole killing device

(71) Applicant: Robert Leroy Dane Dane, Toledo, OH (US)

(72) Inventor: Robert Leroy Dane Dane, Toledo, OH (US)

(21) Appl. No.: 13/987,313

(22) Filed: Jul. 29, 2013

(51) Int. Cl. A01M 27/00

(52) U.S. Cl. CPC A01M 27/00

(57) ABSTRACT

A Portable, Manually operated Pest Killing Device is provided for rodents such as Moles and Chip Monks. This device is capable of killing them where they nest and travel. The striking head has 15 sharp spikes. 2 Compression Springs are located on opposite sides of the main frame. When pressure is applied to the steel Foot Rail the striking head and 15 Spikes are pressed deep into the ground. When pressure on Foot Rail is released, both Springs automatically lift the Striking Head with 15 spikes from the ground. Moles and Chip Monks leave fresh mounds and tunnel trails telling you where they are and where they are headed. All you have to do is repeat the above procedure and work these areas. The Protection Plate covers all of the spikes.

### DESCRIPTION OF THE PREFERRED EMBODIMENT

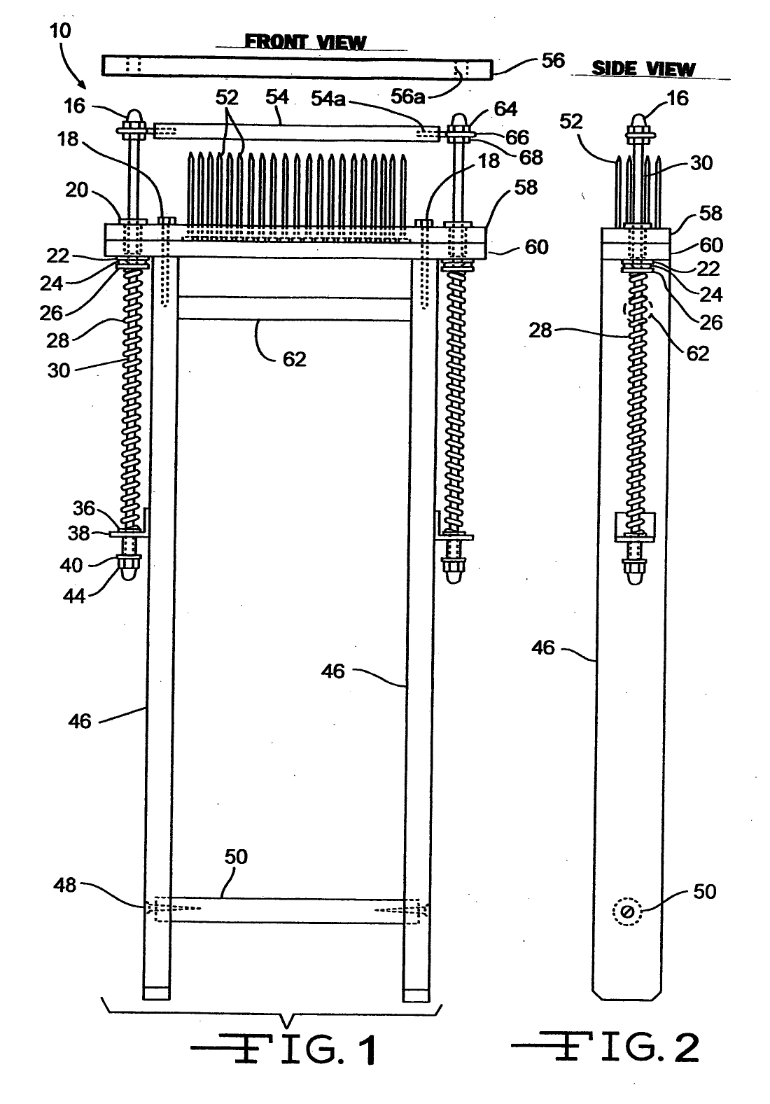

A Portable Pest Killing Device for smaller underground rodents such as Moles and Chip Monks is provided which is capable of killing them underground where they nest and travel. The main frame consists of 2 vertical members 46 and 46 as shown in FIG. 1 connected by 5 horizontal members. Starting at the top the first horizontal member is the handle 50 as shown in FIG. 1. The second horizontal member is the Steel Foot Rail 62 as shown in FIG. 1. The third horizontal member is the Support Plate 60 as shown in FIG. 1. The forth horizontal member is the Striking Plate 58 as shown in FIG. 1. It contains 15 sharp spikes 52 as shown in FIG. 1. The fifth horizontal member is the Recovery Bar 54 as shown in FIG. 1 is powered by 2 Recovery Springs FIG. 28. The Protection Plate 56 as shown in FIG. 1 covers all 15 sharp spikes 52 as shown in FIG. 1. It is applied mainly for storage when not in use. It has two holes drilled into the middle of each end section of the Strike Plate and the Support Plate that are used to connect them to the flat bottom section of each vertical member with two lag screws 18 as shown in FIG. 1. The Support Plate 60 is the same size and shape as the Strike Plate. The support Plate is placed the back side of the Striking Plate as shown in FIG. 1. The Support Plate serves as a base and is designed to support the spikes and prevent movement. Both parts are connected at the same time. The two bushings mentioned that are inserted into 2 steel right angles 38 as shown in FIG. 1. The 2 right angle brackets are both mounted with 2 screws on the outside of each vertical member. Each steel rod 30 as shown in FIG. 1 is spring loaded and each passes through a right angle bracket with a bushing mounted within it. This provides for a very smooth movement of action. Both steel rods 30 as shown in FIG. 1 are incased in a Recovery Spring 28. These rods are threaded and each has a Stop Nut 68 as shown in FIG. 1. Located just below the Support Plate 60 as shown in FIG. 1 is a washer 22, cotter key 24 and a washer 26. Combined these 3 parts form a stop mechanism for both Recovery Springs 28 as shown in FIG. 1. This allows for a space adjustment and also a stop. The right angle bracket 38 with the installed bushing 36 as shown in FIG. 1 is then attached to the outside mid section of each vertical section of the main frame 46 and 46 as shown in FIG. 1. Then the top end of the steel rod is placed through the bushing 36 as shown in FIG. 1 and then the Acorn Nut 44 is attached as shown in FIG. 1. The fifth Steel Recovery Bar 54 as shown in FIG. 1 is a length of metal with holes drilled at opposite ends. These holes are designed to line up and allow each of the Recovery Rods 30 to pass through each hole. The bottom ends of the Recovery Rods are supported with 2 Support Nuts 68 as shown in FIG. 1. Then the 2 Support Nuts 68 as shown in FIG. 1. Next the Recovery Bar is now connected to both threaded spring loaded Vertical Steel Rods with 2 Holding Nuts 64 as show in FIG. 1. The Acorn Nut 16 as shown in FIG. 1 is attached on top of the Holding Nuts 68. When connected, the Recovery Bar 66 as shown in FIG. 1 is designed to line up in a center position between the 2 rows of Steel Spikes for clearance of full movement to the base of the Strike Plate 58. When downward pressure is applied on the Foot Rail the 15 spikes in the Strike Plate are pressed deep into the ground. When the foot pressure is released from the Foot Rail 62 as shown in FIG. 1 the Recovery Bar with its spring loaded mechanism retracts with a pulling action removing the Strike Plate with its 15 spikes from the ground at an above ground level position ready for the next strike. The Recovery Bar 54 as shown in FIG. 1 went into motion before the spikes entered the ground. When the downward pressure is released the Recovery. Bar 54 as shown in FIG. 1, it pulls the strike plate from the ground automatically. You do not have to pull the Strike Plate and its 15 spikes from the ground. This device does it for you automatically every time. It also allows you to have a large number of strikes that you think are necessary in a very short time. 10 Strikes×15=15 individual Strikes. That represents a great deal of coverage. The Protector Plate 56 as shown in FIG. 1 covers all spikes and attaches with 2 nuts at the very top of the main frame. This is used for storage when not in use.

### BACKGROUND OF THE INVENTION

Excavations of Ancient Roman sites have revealed countless earthenware pots that they were burled Into the ground. It is believed that the pots were filled with water and acted as a trap for Moles, it was simple yet a deadly trap. When any that would fall into the pot it would drown in the water. As time went on traps to catch Moles have become more and complicated. Mole traps went from clay to wood and eventually steel.

During my Patent Search I found many mole traps that were spring loaded with a trigger device that would go off when it was moved by a Mole. You would set the trap and then you would wait for a Mole to set the trap off. I have done this many times and I always thought that waiting was a waste of time and should not be necessary. Moles usually leave fresh mounds and a trail of new tunnels telling you where they are and where they are headed. That is why I invented this Portable Pest Killing Device For Underground Rodents. It works very well for me, so I would like to have it Patented.

### SUMMARY OF THE INVENTION

I have over one acre of lawn and I have used 6-10 Mole Traps at one time. Mole Traps did not work that well. I have been there and done that. Waiting is a total waste of time. I decided that waiting was not necessary and that I should be more aggressive. Next I sketched MOLE-O-MATIC and then I built it. MOLE-O-MATIC is lightweight, portable, manually operated and easy to use. Now I was in control and I was determined to apply this device aggressively and I did. Early results were very good. I discovered (multiple saturated strikes) actually worked very well. When foot pressure is released from the steel foot rail the 15 sharp spikes are automatically retracted from the ground every time. Each hit=15 Strikes. I took one new Mole hill centered on one square yard of space and applied about 30 Hits×15=450 strikes. MOLE-O-MATIC did the job, the Mole activity was gone. Multiple saturation strikes are the KEY. This is a New Concept when properly applied can be the answer to the Mole problem. This New Concept should be introduced to the market with MOLE-O-MATIC. You must be very aggressive when using this device as I have described above. There is no waiting period and no traps to set. MOLE-O-MATIC is ready to go to work now. My tests have proven to me that multiple saturation strikes are far more effective than common Mole Traps and also a time saver. Before putting MOLE-O-MATIC away after using it, a Protection Plate covering all spikes is attached with 2 Acorn Nuts for safety. Because of the Mole digging activity, the Mole Hills and the Mole Tunnels have softened the ground in all these work areas. This softened ground allows the 15 Spikes on the Strike Plate to enter the ground with minimum resistance making this tool easier to use. This softened ground works in favor with MOLE-O-MATIC by allowing the procedure to be completed easily and quickly with little effort. At present my Moles are gone, however if they return, they will not have a chance with MOLE-O-MATIC'S 15 multiple and retractable deep strikes per hit striking many times.

What is claimed is:

1. Main frame consists of 2 vertical members connected by 6 horizontal members consisting of:
a) 2 Vertical members connected by a horizontal Handle 50 FIG. 1.
b) 2 Vertical members connected by a horizontal Steel Foot Rail 62 FIG. 1.
c) 2 Vertical members connected by a horizontal Support Plate 60 FIG. 1.
d) 2 Vertical members connected by a horizontal Striking Plate 58 FIG. 1.
e) 2 vertical members connected by a horizontal Recovery Bar 54 FIG. 1.
f) 2 vertical members connected by a horizontal Protection Plate 56 FIG. 1.

2. The Power Pack consisting of 2 Recovery Springs 28 FIGS. 1 and 2 Recovery Steel Rods 30 FIGS. 1 and 2 right angle brackets 38 FIG. 1 with installed Bushings 36 FIG. 1 and Recovery Bar 66 FIG. 1. The Recovery Bar 66 FIG. 1 is a length of aluminum channel with holes drilled at opposite ends. These ends are connected to the tips of the two Recovery Rods 30 FIG. 1 as shown in FIG. 1 and FIG. 2. The Recovery Bar is located to fit between the two rows of Spikes on the Strildng Plate 58 FIG. 1.

4. The Striking Plate 58 with the 15 sharp spikes 52 mounted in 2 rows, 1 row with 7 spikes and 1 row with 8 splices. Facing each other these rows are in a staggered position to provide more complete coverage with each other during each strike. The Striking Plate is connected in place to the main frame with 2 Lag Screws 18 located at opposite ends on top of the support plate 60 as show in Front View of FIG 1. The number of sharp spikes is a matter of choice.
